(19) United States
(12) Patent Application Publication
(10) Pub. No.: US 2016/0133103 A1
(43) Pub. Date: May 12, 2016

(54) COMMODITY SALES DATA PROCESSING APPARATUS, DOCKING STATION USED IN THE SAME COMMODITY SALES DATA PROCESSING APPARATUS, AND CONTROL METHOD FOR THE DOCKING STATION

(71) Applicant: TOSHIBA TEC KABUSHIKI KAISHA, Tokyo (JP)

(72) Inventor: Mikihiro Kanomata, Izunokuni (JP)

(21) Appl. No.: 14/937,933

(22) Filed: Nov. 11, 2015

(30) Foreign Application Priority Data
Nov. 11, 2014 (JP) 2014-229008

(51) Int. Cl. G07G 1/00; G07G 1/12; H02J 7/00; G07G 5/00; G06F 1/16; G06F 1/18

(52) U.S. Cl. CPC G07G 1/0018; G06F 1/1632; G06F 1/1696; G06F 1/189; H02J 7/0072; G07G 5/00; G07G 1/12

(57) ABSTRACT

In accordance with an embodiment, a commodity sales data processing apparatus includes a portable data processing terminal which is loaded with a battery and carries out data processing relating to commodity sales, and a docking station which is arranged separately from the data processing terminal and comprises a printer, a port, a power supply unit and a control unit. The port is used to connect with the data processing terminal. The power supply unit supplies electric power to the data processing terminal that is connected with the port and to the printer. During the period the printer is printing, the control unit carries out a control processing for prohibiting charging the battery loaded in the data processing terminal that is connected with the port with the electric power supplied from the power supply unit.

### CROSS-REFERENCE TO RELATED APPLICATION

This application is based upon and claims the benefit of priority from Japanese Patent Application No. 2014-229008, filed Nov. 11, 2014, the entire contents of which are incorporated herein by reference.

### FIELD

Embodiments described herein relate generally to a commodity sales data processing apparatus, a docking station used in the commodity sales data processing apparatus, and control method for the docking station.

### BACKGROUND

In a store, a technology has been realized in which data processing (commodity sales data processing) relating to commodity sales is carried out through a tablet terminal.

In general, the tablet terminal doesn't comprise a printer. However, it is not practical to constitute a data processing terminal provided with a tablet terminal and a printer. Thus, it is considered to arrange a docking station and a data processing terminal separately from each other, wherein the docking station is provided with a printer.

The docking station is possible to mount on/detach from the data processing terminal. If the docking station supplies electric power to the mounted data processing terminal thereon, the docking station can be very conveniently used. Thus, in the docking station, it is considered to provide a power supply unit which not only supplies electric power to the electric elements in the docking station but also supplies electric power to the data processing terminal.

However, in this case, it is necessary to increase the power supply capacity of the power supply unit such that the maximum power consumption in the docking station and the maximum power consumption in the data processing terminal can be output simultaneously, which may lead to an increase in both the size and the cost of the power supply unit.

Thus, it is desired to reduce the power supply capacity of a power supply unit of a docking station.

### BRIEF DESCRIPTION OF THE DRAWINGS

FIG. 1 is an external perspective view illustrating a commodity sales data processing apparatus according to an embodiment;

FIG. 2 is another external perspective view illustrating the commodity sales data processing apparatus according to an embodiment;

FIG. 3 is a block diagram illustrating the electric elements of the commodity sales data processing apparatus shown in FIG. 1 and FIG. 2; and

FIG. 4 is a flowchart illustrating a control processing by a CPU shown in FIG. 3.

### DETAILED DESCRIPTION

In accordance with an embodiment, a commodity sales data processing apparatus includes a portable data processing terminal which is loaded with a battery and carries out data processing relating to commodity sales, and a docking station which is arranged separately from the data processing terminal and comprises a printer, a port, a power supply unit and a control unit. The port is used to connect with the data processing terminal. The power supply unit supplies electric power to the data processing terminal that is connected with the port and to the printer. During the period the printer is printing, the control unit carries out a control processing for prohibiting charging the battery loaded in the data processing terminal that is connected with the port with the electric power supplied from the power supply unit.

Hereinafter, an example of embodiments is described with reference to the accompanying drawings.

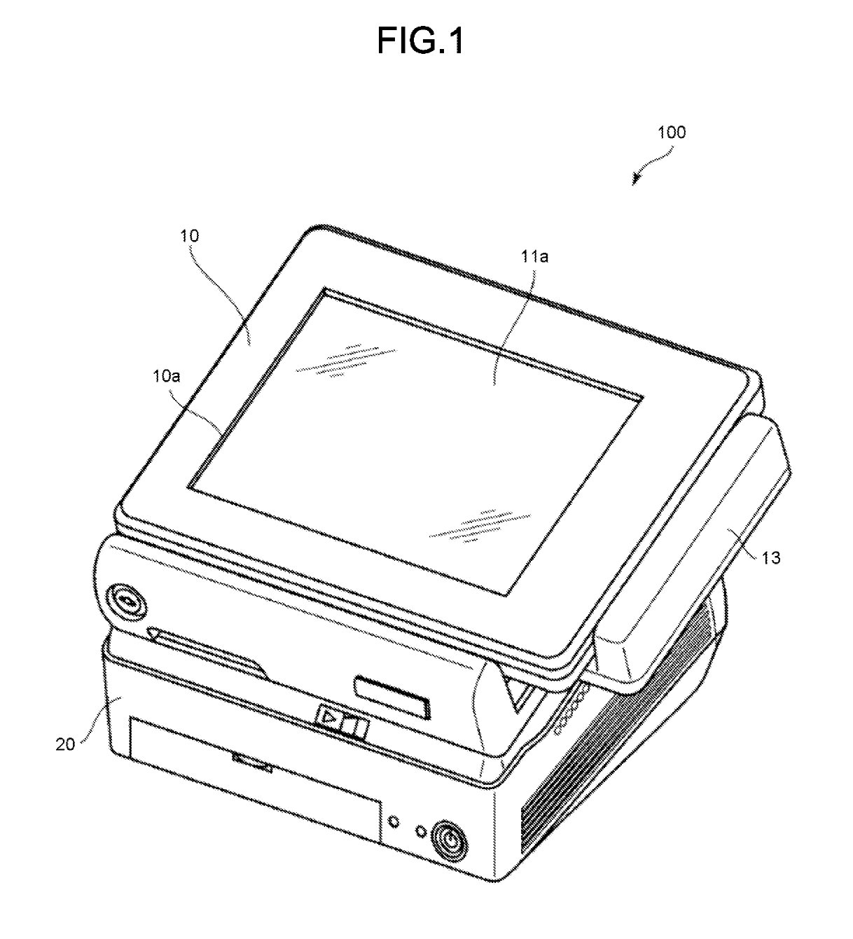

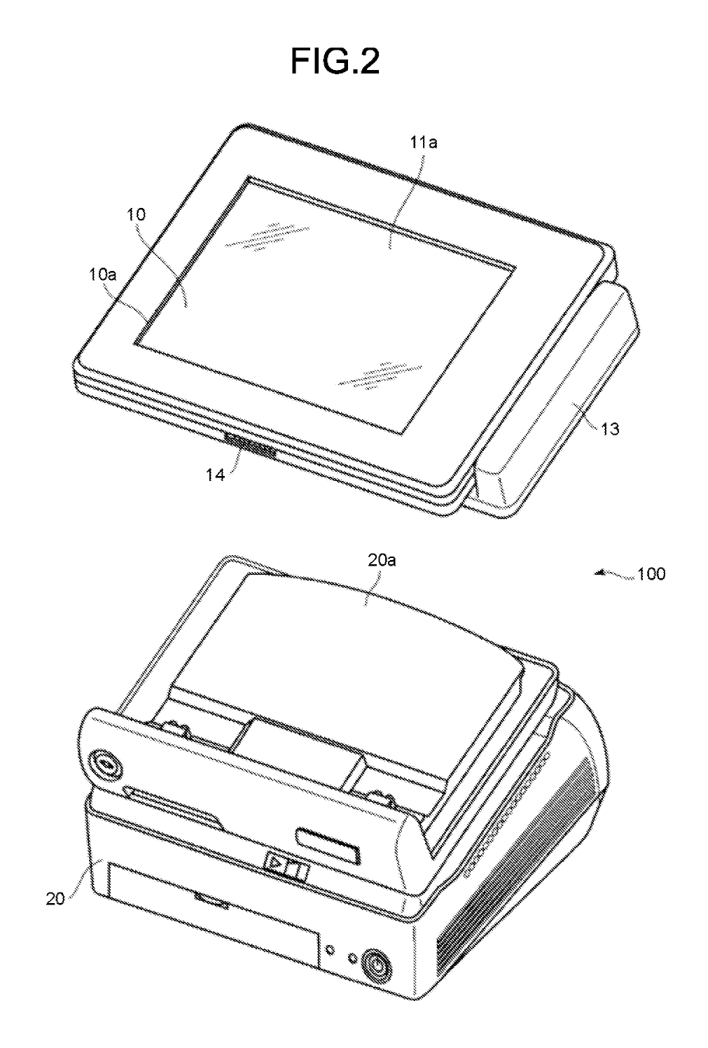

FIG. 1 and FIG. 2 are respectively an external perspective view illustrating a commodity sales data processing apparatus (hereinafter referred to as a “processing apparatus”) 100 according to the present embodiment.

The processing apparatus 100 includes a data processing terminal 10 and a docking station 20.

The data processing terminal 10 and the docking station 20 are separated from each other. The data processing terminal 10 is detachable from the docking station 20. In this way, the processing apparatus 100 can be formed in the two states respectively shown in FIG. 1 and FIG. 2. The state shown in FIG. 1 is that the data processing terminal 10 is mounted on the docking station 20. Hereinafter, this state is referred to as a “mounting state”. The state shown in FIG. 2 is that the data processing terminal 10 is detached from the docking station 20. Hereinafter, this state is referred to as a “separating state”.

The data processing terminal 10 is constituted by covering a jacket 12 on a tablet type personal computer (hereinafter referred to as a tablet PC) 11. The jacket 12 has an opening 10a to enable an operation surface of a touch panel 11a of the tablet PC 11 to be exposed outside . A connector 14 used to connect the data processing terminal 10 to the docking station 20 electrically and a reader/writer 13 are arranged in the jacket 12.

The reader/writer 13 reads data recorded in a data card. The reader/writer 13 also writes data into the data card. In addition to a settlement card such as a credit card, a debit card, an electronic money card, a prepaid card and the like, the card may be various cards which record information relating to settlement processing such as a members card, a point card and the like. The reader/writer 13 may be any one of a magnetic type device, a contact type device, or a non-contact type device, and may also be various kinds of devices. Further, it is exemplified in FIG. 1 and FIG. 2 that the reader/writer 13 is a magnetic type device.

The docking station 20 is equipped with a placing surface 20a for placing the data processing terminal 10 thereon. Though not shown in FIG. 1 and FIG. 2, a connector is arranged in the docking station 20 to be connected with the connector 14 in the mounting state.

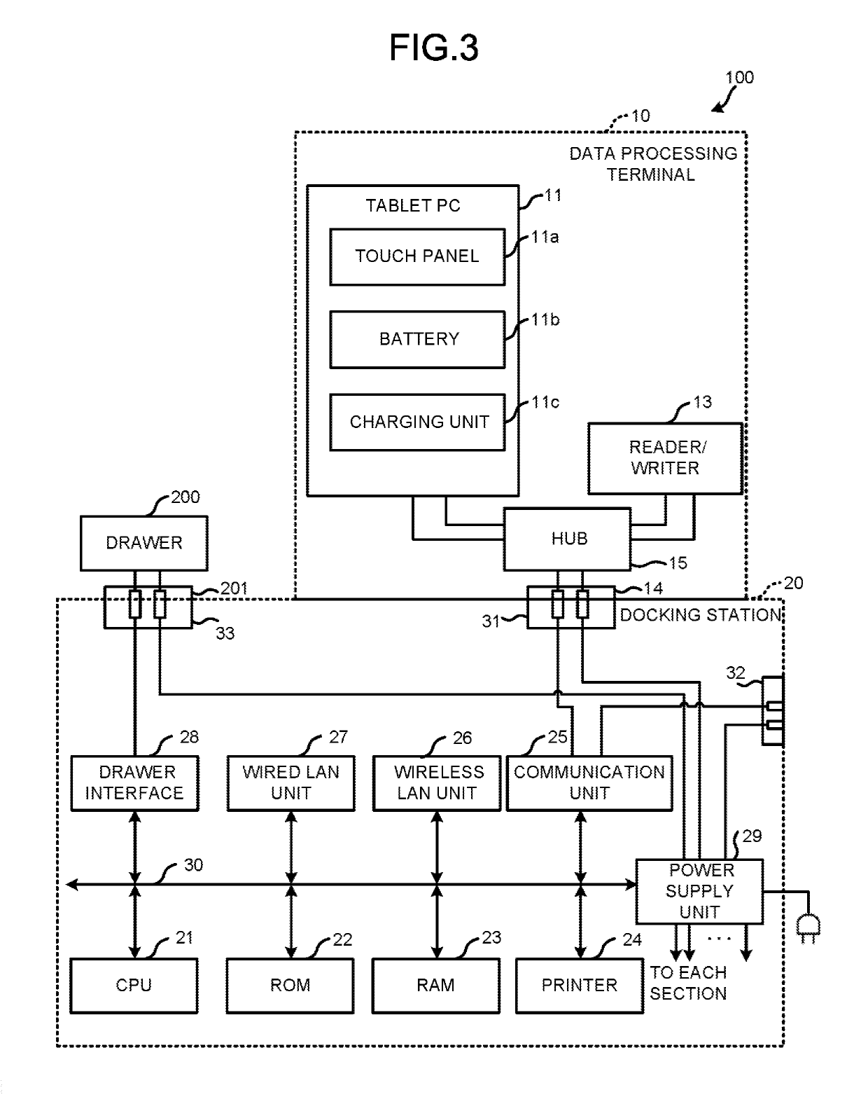

FIG. 3 is a block diagram illustrating the electric elements of the processing apparatus 100. Further, in FIG. 3, the same components shown in FIG. 1 and FIG. 2 are applied with the same reference numerals as shown in FIG. 1 and FIG. 2.

In addition to the tablet PC 11, the reader/writer 13 and the connector 14, the data processing terminal 10 further includes a hub 15.

The hub 15 is connected with the tablet PC 11, the reader/writer 13 and the connector 14 respectively. The hub 15 enables a data communication between the tablet PC 11 and the reader/writer 13 and a data communication between the tablet PC 11 and the docking station 20. In the mounting state, the hub 15 supplies the electric power supplied via the connector 14 from the docking station 20 to the tablet PC 11 and the reader/writer 13. In the separating state, the hub 15 supplies the electric power output from a battery 11b that is arranged inside the tablet PC 11 to the reader/writer 13. The data communication between the tablet PC 11, the reader/writer 13 and the docking station 20 can be carried out using, for example, an existing standard. As an example, it is assumed that the USB (universal serial bus) is used. In this case, an existing USB hub can be used as the hub 15.

The docking station 20 includes a CPU (central processing unit) 21, a ROM (read-only memory) 22, a RAM (random-access memory) 23, a printer 24, a communication unit 25, a wireless LAN unit 26, a wired LAN unit 27, a drawer interface 28, a power supply unit 29, a transmission system 30 and connectors 31, 32 and 33.

The CPU 21, the ROM 22 and the RAM 23 are connected to each other through the transmission system 30 to constitute a computer.

The CPU 21 is a center part of the computer. The CPU 21 controls each section to realize various operations of the docking station 20 based on an operating system, a middleware and application programs stored in the ROM 22 and the RAM 23.

The ROM 22 is a main storage part of the computer mentioned above. The ROM 22 stores the operating system. The ROM 22 also stores the middleware and the application programs mentioned above. As occasional demands, the ROM 22 also stores data referred to when the CPU 21 carries out various processing.

The RAM 23 is a main storage part of the computer mentioned above. The RAM 23 stores the data referred to when the CPU 21 carries out various processing. Further, the RAM 23 is used as a so-called work area for storing the data used temporarily when the CPU 21 carries out various processing.

The application programs stored in the ROM 22 includes a control program which is described in a control processing described later. In general, the transfer of the docking station 20 is carried out in a state in which the control program is stored in the ROM 22. However, the docking station 20 may be transferred in a state of not storing the control program in the ROM 22, and the control program transferred separately may be written into an auxiliary storage unit arranged independently. The transfer of the control program can be carried out by recording it in a removable storage medium such as a magnetic disc, a magnetic optical disk, an optical disk, a semiconductor memory and the like, or through a communication via the network. For example, an EEPORM (electric erasable programmable read-only memory), an HDD (hard disk drive) or an SSD (solid state drive) can be used as the auxiliary storage unit.

For example, the printer 24 is a thermal printer, a impact dot printer and the like. The printer 24 is mainly used to issue a receipt by printing various character strings, images and the like on a receipt paper.

The communication unit 25 communicates with the data processing terminal 10 connected through the connector 31, and communicates with an external device connected through the connector 32. For example, the USB communication device can be used as the communication unit 25. Then, a port, which is used for connecting with the data processing terminal 10, is constituted by the communication unit 25 and the connector 31. In the mounting state, the data processing terminal 10 is connected to the port.

The wireless LAN unit 26 carries out a data communication through a wireless LAN. The wireless LAN unit 26 may be, for example, an existing communication device conforming to the IEEE 802.11 series standard. The wireless LAN unit 26 is mainly used to carry out a wireless data communication with the data processing terminal 10.

The wired LAN unit 27 carries out a data communication through a wired LAN. The wired LAN unit 27 may be, for example, an existing communication device conforming to the IEEE 802.3 series standard. The wired LAN unit 27 is mainly used to carry out a wired data communication with a POS (point of sales) server (not shown).

The drawer interface 28 intermediates the communication between the drawer 200 and the CPU 21 connected with each other through the connector 33 and a connector 201.

The power supply unit 29 receives electric power supplied from a commercial power supply to operate, and supplies the operating power to each of the electric elements included in the docking station 20 and to the data processing terminal 10.

The transmission system 30 transmits the data received and transmitted between the CPU 21, the ROM 22, the RAM 23, the printer 24, the communication unit 25, the wireless LAN unit 26, the wired LAN unit 27, the drawer interface 28 and the power supply unit 29. The well-known devices including various buses such as a system bus, or various interface circuits connecting these buses with each section can be used as the transmission system 30.

The connector 31 is electrically combined with the connector 14 in the mounting state.

The connector 32 is electrically combined with a connector (not shown) which is installed on a connection cable with the external machine (not shown).

The connector 33 is electrically combined with the connector 201 which is installed on a connection cable with the drawer 200.

Further, the connectors 14, 31, 32, 33 and 201 are shown in FIG. 3 schematically, and there are more connectors in practice.

Next, operations of the processing apparatus having the constitutions above are described.

In the separating state, the data processing terminal 10 operates using the electric power stored in the battery 11b of the tablet PC 11. In the mounting state, the data processing terminal 10 operates using the electric power supplied from the power supply unit 29. In this state, a charging unit 11c of the tablet PC 11 charges the battery 11b using the electric power supplied from the power supply unit 29.

The data processing terminal 10 carries out a data processing relating to commodity sales by executing the application programs in the tablet PC 11. The data processing relating to commodity sales refers to a processing carried out by an existing POS terminal, a cash register and the like. In both the mounting state and the separating state, the data processing terminal 10 can carry out the data processing described above. However, since the data processing terminal 10 doesn't comprise a printer, it cannot issue a receipt. When a print job is essential, the tablet PC 11 requests the docking station 20 to print. Such a print request is carried out through wired communication via the connectors 14 and 31 in the separating state, and is carried out through wireless communication via a wireless LAN.

The data processing terminal 10 may select any one of the plurality of the docking stations 20 according to an instruction of a user or a predetermined condition, and request the selected docking station 20 to print. In this case, the data processing terminal 10 that is mounted on one docking station may request another docking station 20 to print through a wireless LAN or a wired LAN. The docking station 20 may receive the print requests from the plurality of data processing terminals 10 respectively.

In this way, the data processing terminal 10 which requests printing and the mounted data processing terminal 10 may be same one, and may also be different one. Therefore, whether the two data processing terminals 10 are the same one or different one, the data processing terminal 10 which requests printing is hereinafter referred to as a requesting terminal, and the processing terminal 10 which is mounted on the docking station 20 receiving the print request is hereinafter referred to as a mounting terminal.

When the print request is received through the communication unit 25, the wireless LAN unit 26 or the wired LAN unit 27, the CPU 21 starts the control processing according to the control program stored in the ROM 22.

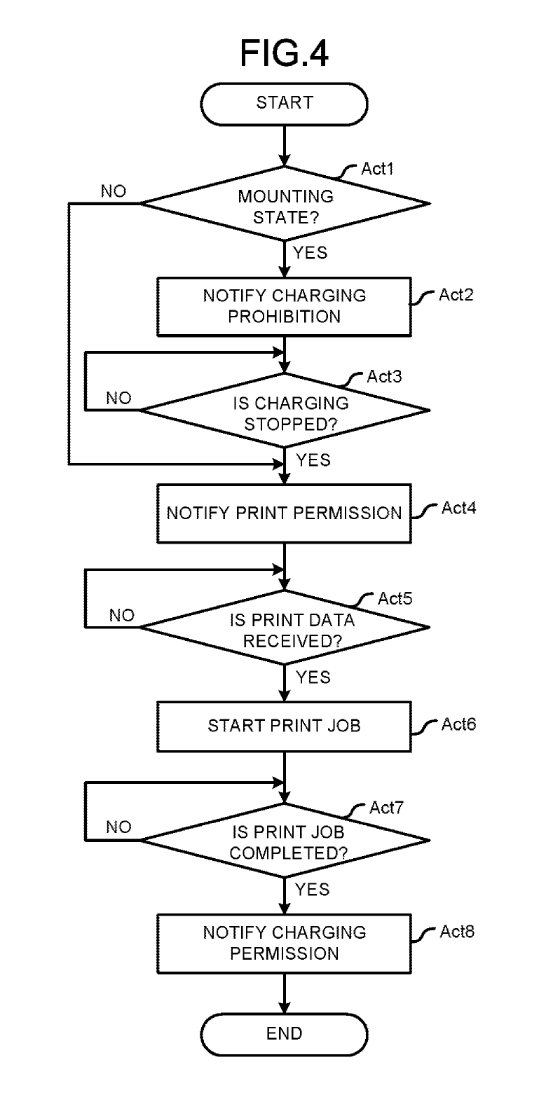

FIG. 4 is a flowchart illustrating the control processing carried out by the CPU 21. Further, the content of the processing described below is an example, and various processing that can obtain same results is also applicable.

In ACT 1, the CPU 21 confirms whether it is the mounting state. The confirmation is carried out by confirming whether or not it is possible to communicate with the tablet PC 11 through the communication unit 25. Alternatively, the docking station 20 may comprise a sensor which detects that the data processing terminal 10 is placed on the placing surface 20a, and whether or not it is the mounting state may be confirmed through the output of the sensor. Then, if it is the mounting state and thus YES is taken in ACT 1, the CPU 21 proceeds to the processing in ACT 2.

In ACT 2, the CPU 21 sends a predetermined charging prohibition command from the communication unit 25 to the tablet PC 11 of the mounting terminal to notify a message indicating prohibit charging the battery 11b. Further, the charging prohibition command may be wirelessly transmitted from the wireless LAN unit 26 to a wireless LAN unit (not shown) of the mounting terminal.

When receiving the charging prohibition command, if the charging unit 11c is charging the battery 11b, the tablet PC 11 stops it.

In ACT 3, the CPU 21 confirms whether or not the charging of the battery 11b in the tablet PC 11 of the mounting terminal is stopped. Then, if the charging has not been stopped yet, the CPU 21 carried out the processing in ACT 3 repeatedly. In this way, the CPU 21 waits for the stop of the charging. The determination mentioned herein may be carried out through any method, for example, an estimation based on a notification from the tablet PC 11, or an estimation based on a power supply state from the power supply unit 29 to the mounting terminal. Then, if the charging has been stopped and thus YES is taken in ACT 3, the CPU 21 proceeds to the processing in ACT 4. Further, if it is the separating state and thus NO is taken in ACT 1, the CPU 21 proceeds to the processing in ACT 4 without carrying out the processing in ACT 2 and ACT 3.

In ACT 4, the CPU 21 sends a predetermined print permission command from the communication unit 25, the wireless LAN unit 26 or the wired LAN unit 27 to the tablet PC 11 of the requesting terminal to notify a message indicating permitting the print.

In ACT 5, the CPU 21 confirms whether or not the receiving of the print data received from the requesting terminal is started. Then, if the receiving of the print data isn't started and thus NO is taken in ACT 5, the CPU 21 repeatedly carries out the processing in ACT 5. In this way, the CPU 21 waits for until the receiving of the print data is started.

In addition, when receiving the print permission command, the tablet PC starts to send the print data. The print data is received by the communication unit 25, the wireless LAN unit 26 or the wired LAN Unit 27. If the receiving of the print data is started and thus YES is taken in ACT 5, the CPU 21 proceeds to the processing in ACT 6.

In ACT 6, the CPU 21 gives an instruction to the printer 24 to start a print job. In response to the instruction, the printer 24 starts the print job corresponding to the print data received by the communication unit 25, the wireless LAN unit 26 or the wired LAN Unit 27.

In ACT 7, the CPU 21 confirms whether or not the print job started as described above is completed. Then, if the print job has not completed and thus NO is taken in ACT 7, the CPU 21 repeatedly carries out the processing in ACT 7. In this way, the CPU 21 waits for until the print job is completed. Then, if the print job is ended and thus YES is taken in ACT 7, the CPU 21 proceeds to the processing in ACT 8.

In ACT 8, the CPU 21 sends a predetermined charging permission command from the communication unit 25 to the tablet PC 11 of the mounting terminal to notify a message indicating permitting charging the battery 11b. Further, the charging permission command may be transmitted wirelessly from the wireless LAN unit 26 to a wireless LAN unit (not shown) of the mounting terminal.

When receiving the charging permission command, if it is necessary to charge the battery 11b, the charging unit 11c of the tablet PC 11 starts to charge the battery 11b. In this way, the CPU 21 terminates the control processing shown in FIG. 4.

By executing the control processing described above by the CPU 21 based on the control program, the computer taking the CPU 21 as the center part functions as a control unit.

In this way, in accordance with the commodity sales data processing apparatus 100, the print job by the printer 24 and the power supply from the power supply unit 29 for charging the battery 11b in the tablet PC 11 of the mounting terminal are not performed simultaneously. The power consumption at the time of the print job by the printer 24 and the power consumption at the time of charging the battery 11b take up the most of the power consumption in the commodity sales data processing apparatus 100. When compared to a case of supplying the power consumption at the time of the print job by the printer 24 and the power consumption at the time of charging the battery 11b at the same time, the electric power capacity can be greatly reduced.

The following various modifications are possible for the present embodiment.

In order to stop charging the battery 11b in the mounting terminal, the electric power supply from the power supply unit 29 to the mounting apparatus may be stopped. However, in this case, if the residual amount of the battery 11b becomes small, the data processing terminal 10 may be not able to operate normally. Thus, it is desired to stop the electric power supply from the power supply unit 29 to the mounting apparatus after confirming that the residual amount of the battery 11b is above a given amount.

As long as the data processing terminal 10 can charge the loaded battery through the power supply from the docking station 20, the data processing terminal 10 may also be not provided with the tablet PC 11.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A commodity sales data processing apparatus, comprising:
a portable data processing terminal configured to be loaded with a battery and to carry out data processing relating to commodity sales; and
a docking station configured to be arranged separately from the data processing terminal, wherein
the docking station further includes a printer; a port used to connect with the data processing terminal; a power supply unit which supplies electric power to the data processing terminal that is connected with the port and to the printer; and a control unit which carries out, during the period the printer is printing, a control processing for prohibiting charging the battery loaded in the data processing terminal that is connected with the port with the electric power supplied from the power supply unit.

2. The commodity sales data processing apparatus according to claim 1, wherein
the control unit notifies the data processing terminal that is connected with the port of charging prohibition before the printer starts a print job, and notifies the data processing terminal that is connected with the port of charging permission after the printer ends the print job; and
the data processing terminal further comprises a charging unit which stops to charge the battery during a period from a moment the charging prohibition is notified to a moment the charging permission is notified.

3. A docking station which constitutes the commodity sales data processing apparatus together with a portable data processing terminal that is loaded with a battery and carries out data processing relating to commodity sales, and is arranged separately from the data processing terminal, comprising:
a printer;
a port configured to be used to connect with the data processing terminal;
a power supply unit configured to supply electric power to the data processing terminal that is connected with the port and to the printer; and
a control unit configured to carry out, during the period the printer is printing, a control processing for prohibiting charging the battery loaded in the data processing terminal that is connected with the port with the electric power supplied from the power supply unit.

4. The docking station according to claim 3, wherein
the control unit notifies the data processing terminal that is connected with the port of charging prohibition before the printer starts a print job, and notifies the data processing terminal that is connected with the port of charging permission after the printer ends the print job.

5. The docking station according to claim 4, wherein
the control unit controls the printer to start a print job after confirming that the battery is not being charged.

6. A control method for a docking station which is arranged separately from a data processing terminal to constitute the commodity sales data processing apparatus together with the portable data processing terminal that is loaded with a battery and carries out data processing relating to commodity sales; and comprises a printer, a port used to connect with the data processing terminal; a power supply unit which supplies electric power to the data processing terminal that is connected with the port and to the printer, including:
carrying out a control processing for prohibiting charging the battery loaded in the data processing terminal with the electric power supplied from the power supply unit during a period the printer is printing.
